(19) United States
(12) Patent Application Publication
(10) Pub. No.: US 2013/0192308 A1
(43) Pub. Date: Aug. 1, 2013

(54) METHOD FOR PRODUCING AND REFINING A GLASS MELT IN A GLASS

(71) Applicants: Harald Zimmermann, Bad Wurzach (DE); Louis Kienle, Mittelbiberach-Reute (DE); Markus Beutinger, Aulendorf (DE)

(72) Inventors: Harald Zimmermann, Bad Wurzach (DE); Louis Kienle, Mittelbiberach-Reute (DE); Markus Beutinger, Aulendorf (DE)

(21) Appl. No.: 13/583,942

(22) PCT Filed: Mar. 14, 2011
(86) PCT No.: PCT/EP11/01244

§ 371 Date: Nov. 14, 2012

(30) Foreign Application Priority Data
Mar. 19, 2010 (DE) 10 2010 012 059.6

(51) Int. Cl. C03B 5/235

(52) U.S. Cl. CPC C03B 5/235
USPC 65/134.4; 65/134.1; 65/356

(57) ABSTRACT

In a method for producing and refining a glass melt in a glass melting end, a mixture is fed to the glass melting end, the mixture is transformed into the glass melt under the action of heat in the glass melting end, and fuel is combusted with air and/or oxygen being supplied above the glass melt in order to generate heat in the glass melting end. In order to improve the thermal conditions inside the glass melting end, according to the invention wood dust is introduced as fuel into the combustion space present above the glass melt in the glass melting end and is combusted there, with air and/or oxygen being supplied.

The invention relates to a method of making and refining a glass melt in a glass-melting furnace, and to a corresponding glass-melting furnace.

In the relevant known methods and glass-melting furnaces of the prior art, a mixture is added to the glass-melting furnace and is there converted or transformed into the glass melt under the action of heat. The heat is generated in the combustion chamber of the glass-melting furnace by fuel being into this combustion chamber for this purpose. Air and/or oxygen is supplied to the combustion chamber to burn the fuel.

Gas burners and/or oil burners are employed in these known methods in that gas or atomized oil is introduced into the combustion chamber and combusted there with the supplied air in order to the maintain the temperature in the glass melt, located therebelow in the glass-melting furnace, within the range required for the processes that take place in the glass-melting furnace.

Based on the above-described prior art, the object of this invention is to provide a method of making and refining a glass melt in a glass-melting furnace, or a glass-melting furnace therefor, in which the combustion of the fuel in the combustion chamber of the glass-melting furnace can be designed more advantageously and combined with a higher efficiency so as also to achieve a retarded consumption by combustion of the fuel and thus a more constant generation of flame as compared with the prior art.

The object is achieved in terms of the method of making and refining a glass melt in a glass-melting furnace by introducing wood dust into the combustion chamber of the glass-melting furnace, the chamber being above the glass-melting furnace, and is consumed by combustion there by supplying air and/or oxygen. Employing wood dust as the fuel enables the generation of flame to be kept constant in the combustion chamber, thereby improving thermal conditions inside the glass-melting furnace. In addition, the use of wood dust as the fuel enables the cost to be reduced for heating the glass-melting furnace. The consumption by combustion of the wood dust produces a high level of radiated heat by the flame together with a distribution of heat over a wide area, where this radiated heat can be readily transferred from the flame into the glass melt in the glass-melting furnace. If the method according to the invention is used, special measures can be eliminated in terms of delaying or retarding the combustion, such as those required, for example, when using gas as the fuel.

In an advantageous embodiment of the method according to the invention, the wood dust can be blown into the combustion chamber of the glass-melting furnace, the combustion chamber being located above the glass melt. This enables an advantageous control of the actual combustion process that accompanies the supply of air and/or oxygen into this combustion chamber.

An especially advantageous embodiment of the method according to the invention uses shredded or ground wood particles as the wood dust. A reduction in the NOx content of the waste gas can be achieved since partially substoichiometric combustion conditions are created in the region—as viewed on the small local scale—of a wood particle.

The quality of the combustion in the combustion chamber can be further enhanced if the wood dust is blown into the combustion chamber together with air, natural gas, oxygen, or any appropriate gas mixture. It is possible, in particular, to enhance the above-mentioned effect with partially substoichiometric combustion conditions by injecting the wood dust with natural gas.

With a glass-melting furnace according to the invention for making and refining a glass melt from a mixture supplied to a glass melt that includes a burner assembly introducing the fuel into the combustion chamber of the glass-melting furnace, the combustion chamber being located above the glass melt, for combustion there with supplied air and/or oxygen, the basic object of the invention is achieved by an approach whereby at least one wood burner is part of the burner assembly that can introduce dust into the combustion chamber of the glass-melting furnace, which combustion chamber is located above the glass melt.

The at least one burner of the burner assembly is advantageously designed so that the burner can inject the wood dust into the combustion chamber of the glass-melting furnace above the glass melt.

The glass-melting furnace, or its wood burner, can be advantageously designed so as to enable air, natural gas, oxygen, or any appropriate gas mixture to be injected along with the wood dust into the combustion chamber of the glass-melting furnace above the glass melt. The use of wood enables biomass to be used as the fuel in the case of the invention.

The following discussion describes the invention in more detail based on one embodiment.

In the method of making and refining of a glass-melting furnace, the glass melt is in the lower region of the glass-melting furnace; a combustion chamber is provided above this inside the glass-melting furnace.

An appropriate metering device supplies to the glass-melting furnace a mixture that contains the material components required to produce glass. This mixture is converted or transformed into the glass melt inside the glass-melting furnace.

To this end, heat is generated inside the glass-melting furnace—specifically to the extent necessary to keep the glass-melting furnace within the temperature range that is required to operate the glass-melting furnace.

In order to generate the heat, fuel in the form of wood dust is blown into the combustion chamber of the glass-melting furnace above the glass melt. Shredded or ground wood particles are used as the wood dust. The wood particles are injected by wood burners that comprise the burner assembly of the glass-melting furnace. Combustion air and/or oxygen are introduced into the combustion chamber in addition to the wood dust.

The wood dust can be injected, for example together with natural gas, into the combustion chamber. This achieves and enhances the effect whereby partially substoichiometric combustion conditions are created in the region of each particle of wood dust, thereby achieving a reduction in the NOx content of the waste gas.

The combustion of the wood dust in the combustion chamber has the effect of achieving a relatively constant generation of flame that produces favorable thermal conditions inside the glass-melting furnace. In addition, the use of wood dust results in significant economic advantages over the fuels known from the prior art, such as oil and gas.

It is conceivable for the burner assembly to include burners functioning with other fuels as determined by specific requirements profiles.

1. A method of making and refining a glass melt in a glass-melting furnace in which a mixture is supplied to the glass-melting furnace, the mixture is converted into the glass melt through the effect of heat in the glass-melting furnace, and fuel is combusted by supplying air or oxygen to generate heat in the glass-melting furnace above the glass melt, characterized in that wood dust is introduced as the fuel into the combustion chamber of the glass-melting furnace, which combustion chamber is located above the glass melt, and combusted there by supplying air or oxygen.

2. The method according to claim 1, wherein the wood dust is blown into the combustion chamber of the glass-melting furnace, the combustion chamber being located above the glass melt.

3. The method according to claim 1, wherein crushed or ground wood particles are used as the wood dust.

4. The method according to claim 1, wherein the wood dust is injected together with air, natural gas, or any appropriate gas mixture into the combustion chamber.

5. A glass-melting furnace for making and refining a glass melt from the mixture supplied to the glass-melting furnace, comprising a burner assembly that can introduce into the combustion chamber of the glass-melting furnace, the combustion chamber being located above the glass melt, the fuel that can be combusted there by supplying air or oxygen, characterized in that the burner assembly includes at least one wood burner that can introduce wood dust into the combustion chamber of the glass-melting furnace, the combustion chamber being located above the glass melt.

6. The glass-melting furnace according to claim 5, wherein at least one wood burner is designed so that the wood dust can be injected by the wood burner into the combustion chamber of the glass-melting furnace above the glass melt.

7. The glass-melting furnace according to claim 5, wherein the wood burner is designed so that air, natural gas, oxygen, or any other appropriate gas mixture can be injected together with the wood dust into the combustion chamber of the glass-melting furnace above the glass melt.
